(19) United States
(12) Patent Application Publication
(10) Pub. No.: US 2014/0356721 A1
(43) Pub. Date: Dec. 4, 2014

(54) Coating Particles

(71) Applicant: University of Southern California, Los Angeles, CA (US)

(72) Inventors: Chongwu Zhou, San Marino, CA (US); Jiepeng Rong, Los Angeles, CA (US); Mingyuan Ge, Los Angeles, CA (US); Xin Fang, Los Angeles, CA (US)

(73) Assignee: University of Southern California, Los Angeles, CA (US)

(21) Appl. No.: 14/291,552

(22) Filed: May 30, 2014

Related U.S. Application Data
(60) Provisional application No. 61/829,589, filed on May 31, 2013.
(60) Provisional application No. 61/906,845, filed on Nov. 20, 2013.

(51) Int. Cl. H01M 4/36

(52) U.S. Cl. CPC H01M 4/366; H01M 2004/028
USPC 429/231.4; 429/246; 429/218.1; 427/212; 427/215

(57) ABSTRACT

A method includes combining a coating material and an uncoated particulate core material in a solution having a selected ionic strength. The selected ionic strength promotes coating of the uncoated particulate core material with the coating material to form coated particles; and the coated particles can be collected after formation. The coating material has a higher electrical conductivity than the core material.

### CROSS-REFERENCE TO RELATED APPLICATIONS

This application claims priority to U.S. Application Ser. No. 61/829,589 filed on May 31, 2013, and U.S. Application Ser. No. 61/906,845 filed on Nov. 20, 2013, both of which are incorporated herein by reference.

### BACKGROUND

Rechargeable batteries having high energy density are important in addressing energy storage and environmental issues. Lithium-ion batteries are one of the more promising rechargeable batteries because of their high energy density. State of the art lithium-ion batteries based on LiCoO₂/graphite, or LiFePO₄/graphite systems have a theoretical energy density of 400 Wh/kg. There is a need to increase energy densities for many emerging applications, such as the powering of electrical vehicles. New anode and cathode materials having higher specific capacity may allow the overall energy density of rechargeable lithium batteries to be increased. As a result, much effort has been devoted to the development of alternative high-capacity anode materials (such as silicon, which has over 4000 mAh/g theoretical capacity, over 10 times higher than commercial graphite's 350 mAh/g). Nonetheless, a limiting factor remains in the relatively low capacity of cathodes (commercial metal oxide based cathodes have specific capacity less than 150 mAh/g).

The ability to use sulfur, which has a theoretical specific capacity is about 1672 mAh/g, as a cathode in lithium-sulfur battery has been investigated. Li—S batteries are promising candidates to power electric vehicles because of their high theoretical energy density of 2567 Wh/kg, which is more than 5 times that of lithium-ion batteries based on traditional insertion compound cathodes such as LiCoO₂, LiFePO₄, and LiMn₂O₄. In addition, elemental sulfur is generally low cost, low toxic, and abundant.

Graphene, a monolayer of carbon atoms tightly packed into a two-dimensional (2D) honeycomb sp² carbon lattice, has drawn significant attention because of its high surface area, chemical stability, mechanical strength and flexibility.

### SUMMARY

Methods disclosed herein can be used to encapsulate sulfur particles with conducting materials, such as graphene oxide, to improve the electronic conductivity of sulfur and limit polysulphide (e.g., Li₂Sₓ, x=4-8) dissolution into electrolytes. The methods also help to reduce (e.g., prevent) a large volumetric expansion (e.g., of ˜80%) of sulfur upon lithiation, which may cause rapid capacity decay and low Coulombic efficiency.

The use of lithiated sulfur can obviate any need for a sulfur cathode to be paired with lithium metal (which supplies lithium) to form a full battery, avoiding safety concerns surrounding the use of lithium metal.

The unique 2D geometry and excellent properties of graphene and graphene oxide (GO) endow them as one the most commonly used coating materials to form core-shell structured composites that can improve the performance of the core materials for many kinds of applications, such as lithium-ion battery electrode materials, corrosion inhibitor, photocatalysts, solar cells, sensors, and drug delivery. The methods described herein allow GO to be coated onto functional particles without the need for surfactants to be used. Such methods eliminate extra steps relating to the determination of the right kind of surfactant for each kind of particle, reducing cost and complexity. The methods also eliminate the need to select a different chemical route for each kind of particles that takes into consideration the different surface chemistry of various particles, yielding a more generic and robust approach for achieving a highly uniform coating on core particles having arbitrary sizes, geometries, and compositions.

The sulfur-based cathode material described herein can enhance the specific capacity of a cathode by a factor of 5, comparing to the state-of-the-art cathode, such as LiCoO₂. It can takes half an hour or less to fully charge or discharge the battery and more than 500 cycles of stable performance have been demonstrated.

Forming a conductive coating layer on sulfur particles to increase the conductivity of the electrode can improve the charge/discharge cycle life and help to commercialize sulfur-based cathodes. Such a method also helps to prevent the dissolution of polysulfide and to accommodate volume expansion. A facile, robust, versatile, and generic method of coating graphene oxide (GO) on particles is described. Sulfur/GO core-shell particles, used as an example in lithium-sulfur (Li—S) battery applications, demonstrated superior performance. By engineering an ionic strength in a solution, particles of different diameters (ranging from 100 nm to 10 μm), geometries, and compositions (sulfur, silicon, carbon) are also successfully wrapped by GO. The GO may be wrinkled GO that is first suspended in an aqueous solution medium. The method does not generally involve chemical reaction between GO and the wrapped particles, and therefore, it can be extended to many kinds of functional particles.

The sulfur/GO core-shell composite material exhibits significant improvements in electrochemical performance over sulfur particles without coating. Galvanic charge-discharge tests using GO/sulfur particles show a specific capacity of 800 mAh/g is retained after 1000 cycles at 1 C(=1 A/g) current rate if only the mass of sulfur is taken into calculation, and 400 mAh/g if the total mass of sulfur/GO is considered. The capacity decay over 1000 cycles is less than 0.02% per cycle. The electrodes described herein can deliver specific capacity of 600 mAh/g at a current rate of 1000 mA/g after 500 cycles. Each charge or discharge process can be completed within 0.5 hour. Compared to a commercially available cathode such as LiCoO₂, the specific capacity of the cathode is increased by a factor of 5.

In one aspect, methods described herein include combining a coating material and an uncoated particulate core material in a solution having a selected ionic strength. The selected ionic strength promotes coating of the uncoated particulate core material with the coating material to form coated particles, and collecting the coated particles. The coating material has a higher electrical conductivity than the core material.

Implementations can include one or more of the following features. Surface energy reduction drives the coating of the core material by the coating material. The particulate core material has a diameter of 10 nm to 100 micron. The coating material is a carbon material or a polymer. The coating material comprises graphene oxide. The methods include reducing the graphene oxide to form reduced graphene oxide coated particles to further increase electrical conductivity. The coated particles are conformally coated with the coating material having a thickness between 1 nanometer and 1 micrometer. The ionic strength of the solution is selected to achieve a wrinkled and crumpled morphology in the coating material on the coated particle. The uncoated particulate core material comprises lithiated sulfur and a ratio of lithium to sulfur is less than or equal to two. The coating material includes a particulate coating material. A cathode for a lithium ion battery that includes the coated particles. The coating material includes graphene oxide (GO), and rich wrinkles in the GO provide space for volume expansion of sulfur upon lithiation and prevent the cathode from disruption. The solution includes an acidic aqueous solution. The acidic aqueous solution includes one or more of hydrochloric acid, nitric acid, sulfluric acid, and acetic acid at a concentration between 0.001 mol/L to 10 mol/L.

In one aspect, batteries described herein include an anode, a cathode having a specific capacity greater than 150 mAh/g; and an electrolyte disposed between the anode and the cathode. The cathode includes conformally coated particles formed from an uncoated particulate core material and a coating material, the coating material having a higher electrical conductivity than the core material.

Implementations can include one or more of the following features. The anode is lithium metal-free. The uncoated particulate core material includes sulfur and the coating material is configured to reduce dissolution of sulfur into the electrolyte. The coating material on the coated particles includes a layer having a wrinkled and crumpled morphology. The wrinkled and crumpled morphology provides space for volume expansion in the cathode that reduces degradation of the cathode. The cathode has a specific capacity greater than 550 mAh/g after 10 charging cycles at a 0.1 C rate and a Coulombic efficiency greater than 99%. The cathode has a specific capacity greater than 500 mAh/g at a 0.1 C rate after operating at a current rate greater than 2 C. The cathode has a specific capacity of not less than 800 mAh/g after 1000 charging cycles at a 1 C rate based on a mass of the core material, and a specific capacity of 400 mAh/g based on a mass of the core material and the coating material. A drop of the specific capacity over 1000 cycles is less than 0.02% per cycle. The coating material includes stacked graphene oxide layers, a spacing between the stacked GO layers forms a channel for lithium ion transportation.

In one aspect, methods described herein includes selecting an ionic strength in a solution based on a combination of uncoated particulate core material and a coating material, combining the coating material and the uncoated particulate core material in the solution having the selected ionic strength, the selected ionic strength promotes coating of the core material with the coating material to form coated particles; and collecting the coated particles. The uncoated particulate core material can be sulfur, lithiated sulfur, silicon, or carbon black, and the coating material can be graphene oxide, or conductive polymers.

### BRIEF DESCRIPTION OF THE DRAWINGS

FIG. 1A is a schematic diagram of a synthesis process.

FIG. 1B is a schematic diagram of a synthesis process.

FIG. 1C shows a digital camera image of graphene oxide (GO) dispersed in different solutions.

FIG. 1D shows the GO dispersion in FIG. 1C after 12 hours.

FIG. 1E shows the result of adding sulfur particles to GO dispersion in FIG. 1C.

FIG. 2A shows a scanning electron microscopy (SEM) image of GO dried directly from a 1 M HCl solution.

FIG. 2B shows a SEM image of GO dried directly from a NH₃.H₂O solution.

FIG. 2C shows a SEM image of sulfur particles without GO coating.

FIG. 2D shows a SEM image of GO-coated sulfur particles.

FIG. 2E shows a SEM image of GO-coated sulfur particles.

FIG. 3A shows a SEM image of GO-coated sulfur particles.

FIG. 3B shows a SEM image of GO-coated sulfur particles.

FIG. 3C shows a SEM image of GO-coated sulfur particles.

FIG. 3D shows a SEM image of GO-coated sulfur particles.

FIG. 3E shows a SEM image of GO-coated silicon particles.

FIG. 3F shows a SEM image of GO-coated commercial carbon black particles.

FIG. 4A shows infrared (IR) spectra of sulfur, GO, and GO-coated sulfur particle.

FIG. 4B shows Raman spectra of sulfur, GO, and GO-coated sulfur particle.

FIG. 5 shows thermal gravimetric analysis (TGA) measurement of sulfur/GO core shell particles.

FIG. 6A shows results from cyclic voltammetry (CV) of sulfur and GO-coated sulfur particle.

FIG. 6B shows Nyquist plots of impedance measurements of sulfur and GO-coated sulfur particle.

FIG. 6C shows specific capacity at different current rates of sulfur and GO-coated sulfur particle.

FIG. 6D shows galvanic charge-discharge performance and Coulombic efficiency of GO-coated sulfur particle at 1 C(=1 A/g) for 1000 cycles.

FIG. 6E shows voltage profiles at different current rates for sulfur.

FIG. 6F shows voltage profiles at different current rates for GO-coated sulfur particle.

FIG. 6G shows voltage profiles of GO-coated sulfur particle after different numbers of cycles.

FIG. 6H shows galvanic charge-discharge performance and Coulombic efficiency of GO-coated sulfur particle.

FIG. 6I shows a charge/discharge cycling measurement of GO-coated sulfur particle at the current rate of 1000 mAh/g.

FIG. 6J shows a charge/discharge voltage profile.

FIG. 7 shows a battery having a cathode formed from GO-coated sulfur particles.

### DETAILED DESCRIPTION

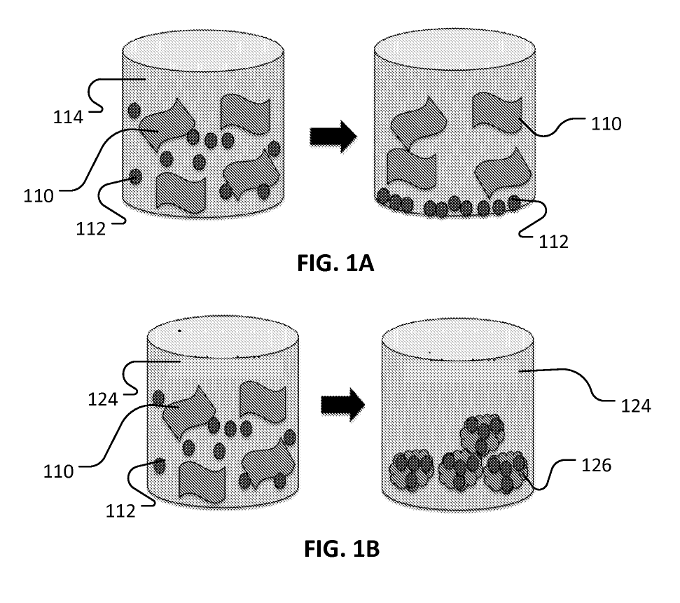

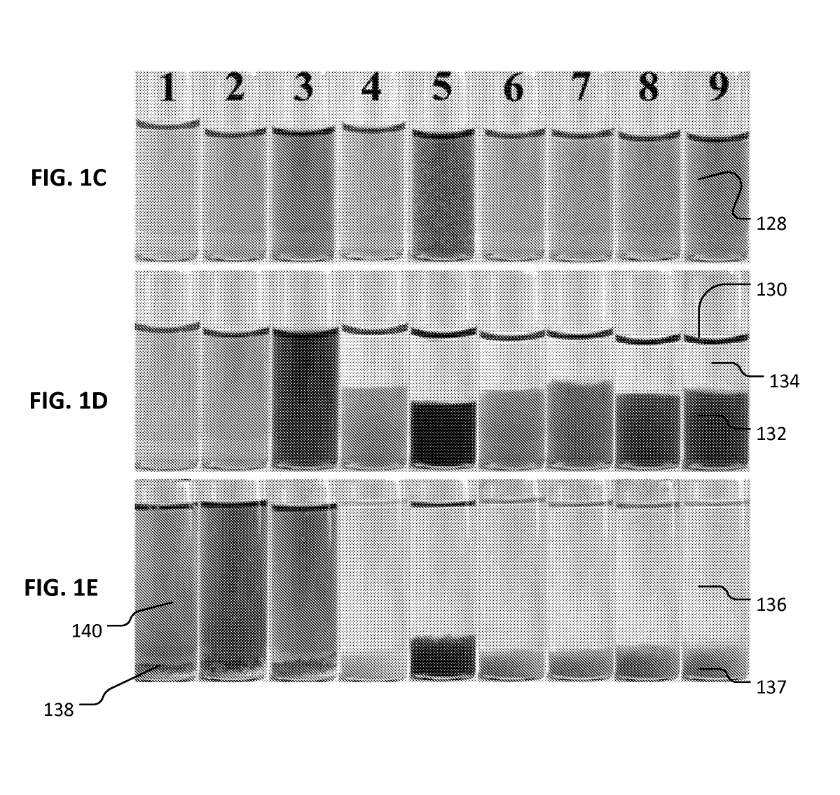

FIG. 1A shows a solution 114 into which a coating material 110 and a particulate uncoated core material 112 are dispersed to form a suspension. When the ionic strength of the solution 114 is not correctly selected, the coating material 110 may stay dispersed in the solution 114 while the particulate uncoated core material 112 form sediments at the bottom of the solution 114. The ionic strength of a solution is a measure of the concentration of ions in that solution. The ionic strength, I, of a solution is a function of the concentration of all ions present in that solution: I=½Σᵢ₌₁ⁿcᵢzᵢ², where cᵢ is the molar concentration of ion i (M or mol/L), zᵢ is the charge number of that ion, and the sum is taken over all ions in the solution.

For example, the solution 114 may be pure distilled water and the coating material 110 may be graphene oxide sheets. Examples of particulate uncoated core material 112 include pure or bare sulfur particles, lithiated sulfur, and silicon particles. No core-shell structure is formed in FIG. 1A. Instead, a mixture of isolated coating material 110 and uncoated core material 112 is obtained. When the uncoated core material 112 is sulfur particles and the coating material 110 is graphene oxide, the product formed in FIG. 1A would not provide much improvement in electrochemical performance as a lithium-ion battery cathode.

FIG. 1B shows a solution 124 into which the coating material 110 and particulate uncoated core material 112 are dispersed to form a suspension. When the ionic strength of the solution is correctly selected, the coating material 110 can be readily coated on the particulate uncoated core material 112 to form core-shell structures 126 which can have different dimension or geometry. For example, solution 124 may be an acidic aqueous solution.

The advantages of core-shell structures that, for example, include a graphene oxide (GO) as the shell and sulfur particles as the core material are fourfold. First, wrapping the sulfur particles can prevent the dissolution of polysulfide into electrolyte. Second, after being coated on sulfur particles, graphene oxide sheets are soft and have a lot of wrinkles, which can provide flexibility and room for volume change and expansion during charging/discharge of a battery having an electrode that incorporates the GO-coated sulfur particles. Third, GO has much better electric conductivity than sulfur, so GO would increase the overall conductivity of the electrode. Fourth, GO is essentially a single-layer or few-layer carbon atoms, which makes a mostly negligible contribution to the weight of the electrode.

Sulfur has a hydrophobic surface while GO has a hydrophilic surface, which makes attaching GO to sulfur challenging. For example, instead of forming the GO sheet/sulfur core-shell structure, they may form a random mixture as shown in FIG. 1A, which does not improve the electrochemical performance of a lithium-ion battery cathode. However, by simply mixing GO and sulfur particles (diameter could be from 10 nanometer (nm) to 10 micron meter; randomly shaped) in a solution at a selected ionic strength (e.g., an aqueous acid solution), improvements in terms of electrochemical performance can be achieved without having to take an extra step or incurring the costs associated with the use of surfactants.

FIG. 1C shows nine different solutions #1-9, each having a different concentration of ions. Some of the solutions are ionic solutions (also known as “electrolyte”) while others are molecular solutions. Each of solutions #1-9 is used as a dispersing medium to prepare different suspensions of coating materials. Ionic strength of solutions #1-9 are estimated and compared in Table 1. The ionic strength is around 1 for ionic solutions, and is more than two orders of magnitude higher than that of molecular solutions.

In general, ionic solutions contain abundant positively and negatively charged ions, which are formed when ionic bonds holding ions together in solute compounds are broken by polar solvents (e.g., water) and the solute compounds dissociate into positively charged cations and negatively charged anions. In contrast, molecular solutions have fewer charged ions because solute compounds may stay as neutral molecules in molecular solutions. The availability of charged ions influences the dispersion of GO in solutions having different ionic strengths.

GO can be prepared by adding, for example, a mixture of concentrated H₂SO₄/H₃PO₄ in a ratio of 360 mL: 40 mL to a mixture of graphite and KMnO₄ at a mass of, for example, 3.0 g and 18.0 g, respectively. The concentration of H₂SO₄ is 98% (or 18 mol/L), and the concentration of H₃PO₄ is 100%. The reaction can be conducted at 50° C. for 12 hours and then cooled to room temperature. The mixture is then poured into ice (for example, about 400 mL) with 3 mL of 30% H₂O₂. 30% H₂O₂ is 30% by weight (w/w) of hydrogen peroxide solution in water, which is 9.79 mol/L. The product is centrifuged at, for example, 4000 rpm for 1 hour, and the supernatant can be decanted. The GO in the supernatant is washed with water, 30% HCl, (10.2 M HCl in water), and water again using a centrifuge.

Chemical exfoliation of graphite can also be used to prepare GO. Although the exact structures of GO are difficult to determine, it is generally believed that GO is rich in epoxides, hydroxyl, ketone carbonyls, and carboxylic groups. Among those functional groups anchored to GO, it is believed that the carboxylic groups and hydroxyl groups help GO form stable colloids in water.

FIG. 1C shows graphene oxide (GO) dispersed in solutions #1-9 as listed in Table 1. Solution 1 contains deionized (DI) water. When GO is dispersed in DI water of solution #1, it forms a stable colloid for days without precipitation. A colloid is a substance that is microscopically dispersed throughout another substance. Colloid can include dispersed particles that are between 2 nm to 1000 nm. In contrast, suspensions generally include dispersed particles that are greater than 1000 nm.

Similar results were also observed in molecular solutions, such as solution #2 which is a 1 M solution of acetic acid (HAc)) and solution #3 which is a 1 M solution of ammonium hydroxide (NH₃.H₂O). In solution #2 and solution #3, solutes (i.e., acetic acid in solution #2, and ammonia in solution #3) remain in the form of molecules after being dissolved in water. These neutral (i.e., uncharged) molecules do not affect electrostatic repulsions among the negatively charged GO, which can still be maintained as a stable suspension in these molecular solutions. GO is negatively charged due to functional groups, such as carboxylic acid groups that are on its surface. Carboxylic acid groups become negatively charged after losing H⁺ in water.

While in ionic solutions, such as #4 (1 M HCl), #5 (1 M NaOH), #6 (1 M NaCl), #7 (NH₄Ac), #8 (1 M NH₄Cl) and #9 (1 M NaAc), the solute compounds readily dissociate into ions after dissolution in water. The positive ions (i.e., H⁺ in solution #4, Na⁺ in solutions #5, #6, and #9, and NH₄⁺ in solutions #7 and #8) will be attracted to and neutralize the negatively charged GO, thereby screening the electrostatic repulsion between GO, and break the stable dispersion of GO. GO are homogeneously dispersed in a stable dispersion, without forming sediments. GO is a stable dispersion in water because all GO membranes are negatively charged. As like charges repel, the repulsive force between GO membranes keep them separated from each other, leading to the formation of a uniform, and stable dispersion. Precipitation of GO was clearly observed after 12 hours in all six ionic solutions as shown in FIG. 1D. For example, solution #9 has the appearance of a generally homogenous suspension 128 at the beginning, as shown in FIG. 1C. FIG. 1D shows a precipitate 132 at the bottom of a clear background solution 134. A marking 130 indicates the original level of suspension 128.

TABLE 1
Comparison of ionic strength of different 1M solutions used for GO coating.

| | DI water | Molecular solutions | | Ionic solutions | | | | | |
|---|---|---|---|---|---|---|---|---|---|
| # | 1 | 2 | 3 | 4 | 5 | 6 | 7 | 8 | 9 |
| Solute | N/A | HAc | NH₃•H₂O | HCl | NaOH | NaCl | NH₄Ac | NH₄Cl | NaAc |
| Ionic strength | 0M | 0.0042M | ~0M | 1M | ~1M | ~1M | ~1M | ~1M | ~1M |

| | | | | | |
|---|---|---|---|---|---|
| Notes | N/A | pKₐ = 4.756 | PKa = 9.245 | pKₐ = −9.3 | Assuming complete dissociation |

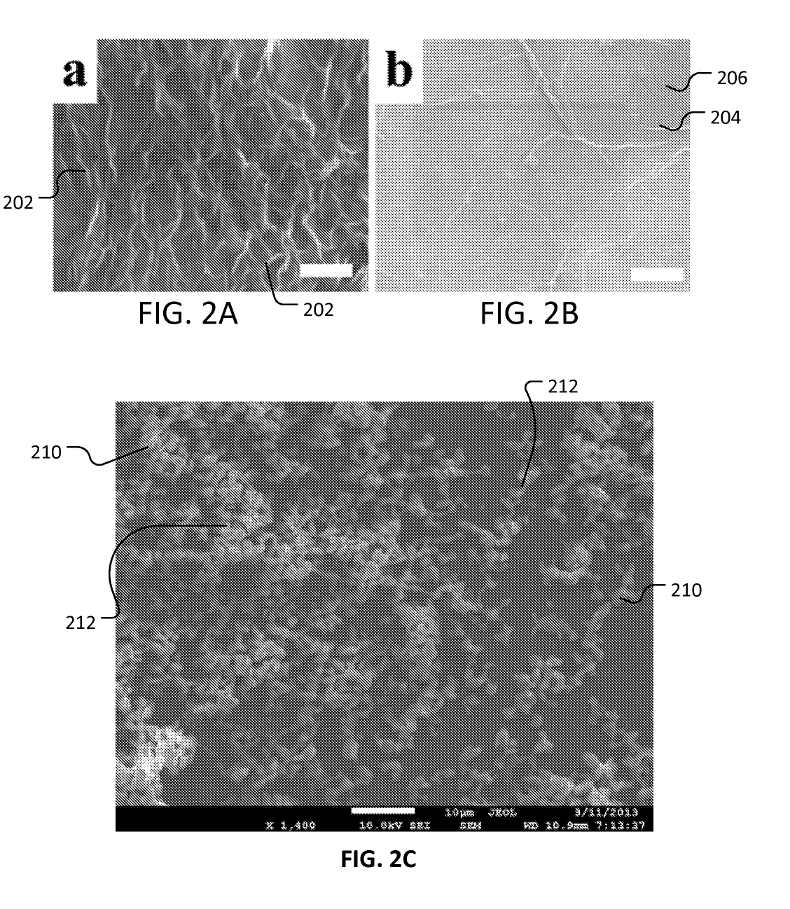

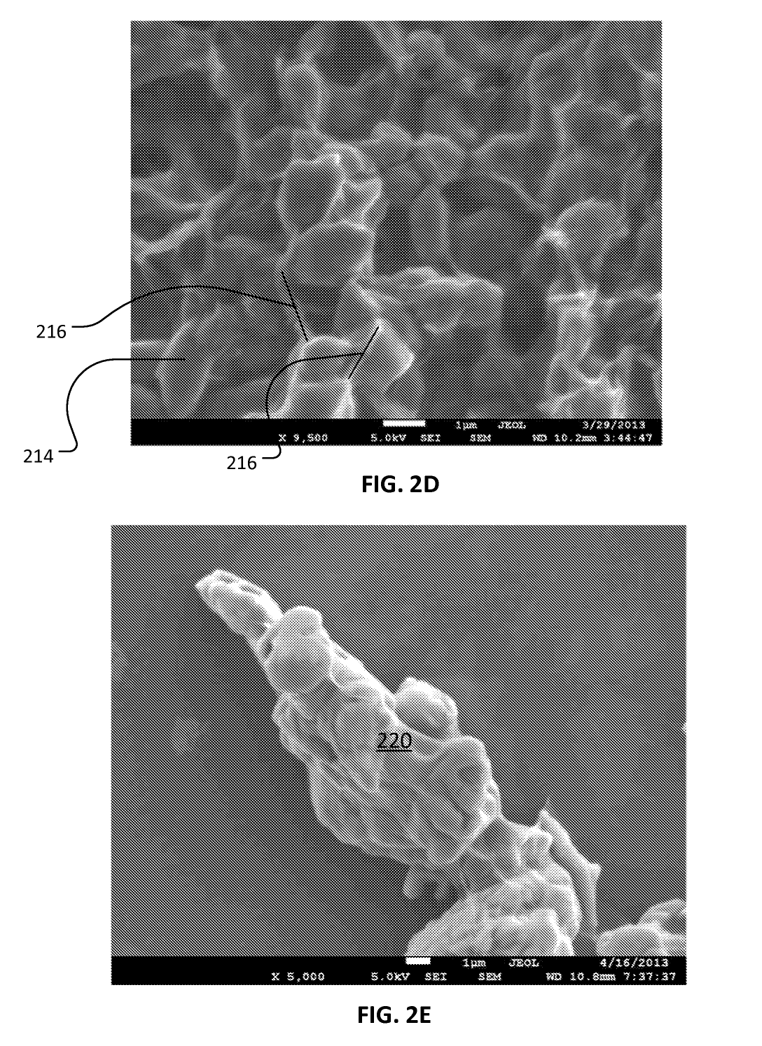

GO from both ionic solutions #4-9 and molecular solutions #1-3 were dried directly without washing, and characterized using scanning electron microscopy (SEM) as shown in FIGS. 2A and 2B. To minimize the effect of solute compounds on characterization, GO from solution #3 (1 M NH₃.H₂O) and solution #4 (1 M HCl) are used as examples of a molecular solution and an ionic solution, respectively. NH₃.H₂O and HCl are understood to evaporate away at elevated temperatures while leaving GO alone. SEM images of GO from ionic solutions in FIG. 2A show a high density of wrinkles 202, indicating that the GO sheet has a wrinkled and crumpled morphology. In contrast, GO from molecular solutions exhibited a rather flat surface. FIG. 2B shows a few wrinkles 204 separated by large regions 206 of flat surfaces. The different morphologies of dried GO are attributed to their different dispersion morphologies in solutions. After GO is dispersed in ionic solutions, the electrostatic repulsive forces among different regions of GO can be screened by positively charged ions (e.g., H⁺, Na⁺, or NH₄⁺), and thus regions of GO do not self-repel as strongly. Instead, GO would tend to crumple, and form wrinkles to minimize its surface energy. Surface energy quantifies the disruption of intermolecular bonds that occur when a surface is created. Surfaces can be intrinsically less energetically favorable than the bulk of a material, that is, the molecules on the surface have more energy compared with the molecules in the bulk of the material. Otherwise, there could be a driving force for surfaces to be created and bulk material would be removed, leading to phenomena like sublimation. Thus, the surface energy can be defined as the excess energy at the surface of a material compared to the bulk. In general, surface area is proportional to surface energy. Thus, when GO form wrinkles, the total surface area (and surface energy) of GO is reduced.

The morphology of GO is maintained after direct drying. In molecular solutions, the negatively charged surface of GO is not influenced by the neutral molecules in solution and GO still stays as a stable dispersion and remains stretched out even after drying. The scale bar in each of FIGS. 2A and 2B corresponds to 1 μm.

When GO is the only additive in ionic solutions, GO tend to crumple, form wrinkles, and restack to minimize their surface energy as shown in FIGS. 2A and 2B. In general, one layer of GO membrane appears very thin and transparent (such as that shown in FIG. 2B). In contrast, FIG. 2A shows many layers of GO membrane restacked together.

In the presence of other particles in ionic solutions, there is an additional way for GO to minimize its surface energy. For example, GO can coat adjacent particles by eliminating an inner side of its surface, and form a core-shell structure in which the particles constitute the core and GO constitutes the shell.

To verify this, sulfur particles having diameters between 1 μm and 10 μm, prepared from hand-grinding commercial sulfur powder with pestle and mortar for five minutes, were used as an example.

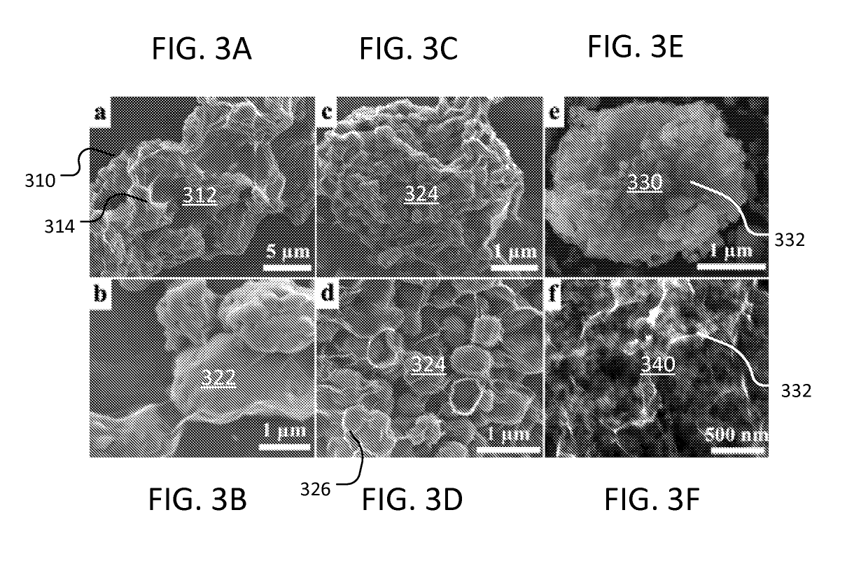

GO and sulfur particles are each separately dispersed in each of solutions #1 to #9 and sonicated for 10 minutes. A GO suspension and its corresponding sulfur suspension, for the set of solutions #1 to #9, were then mixed together and stirred for 1 hour. As expected, ionic solutions and molecular solutions showed different behaviors. In ionic solutions (#4 to #9), GO precipitated together with sulfur particles to form sediments 137 that settle at the bottom of the clear solution 136. SEM characterization of the sediments confirms that the wrinkled GO conformally coated some (e.g., all) sulfur particles to form sulfur/GO core-shell structures, as shown in FIGS. 3A and 3B, which are SEM images of the core-shell structures. The precipitate can be collected, and washed with water and ethanol using a centrifuge. The product can then be dried at 60° C. in air for 12 hours. Sulfur/GO core-shell particles synthesized using different ionic solutions showed no obvious difference in morphology under SEM.

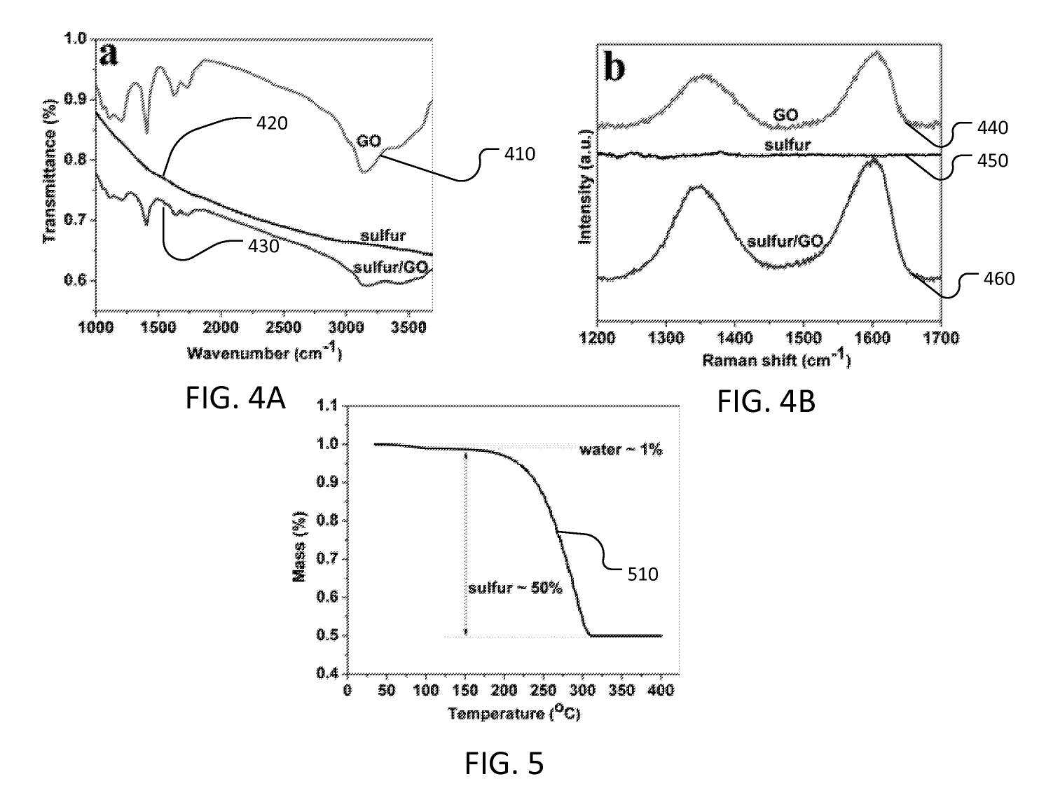

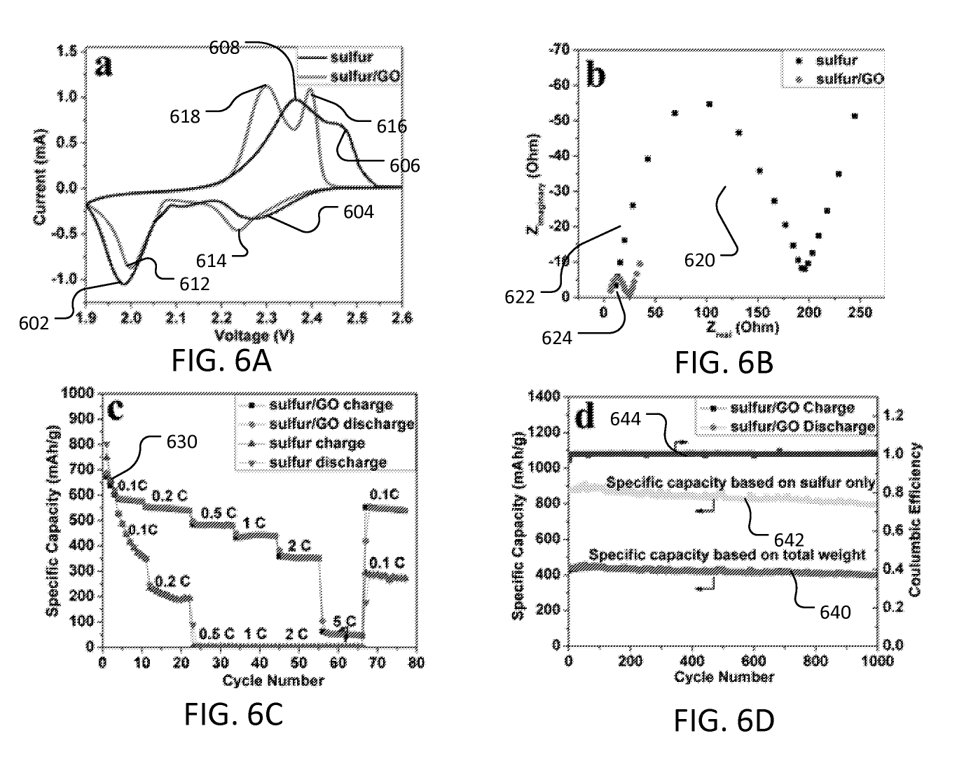

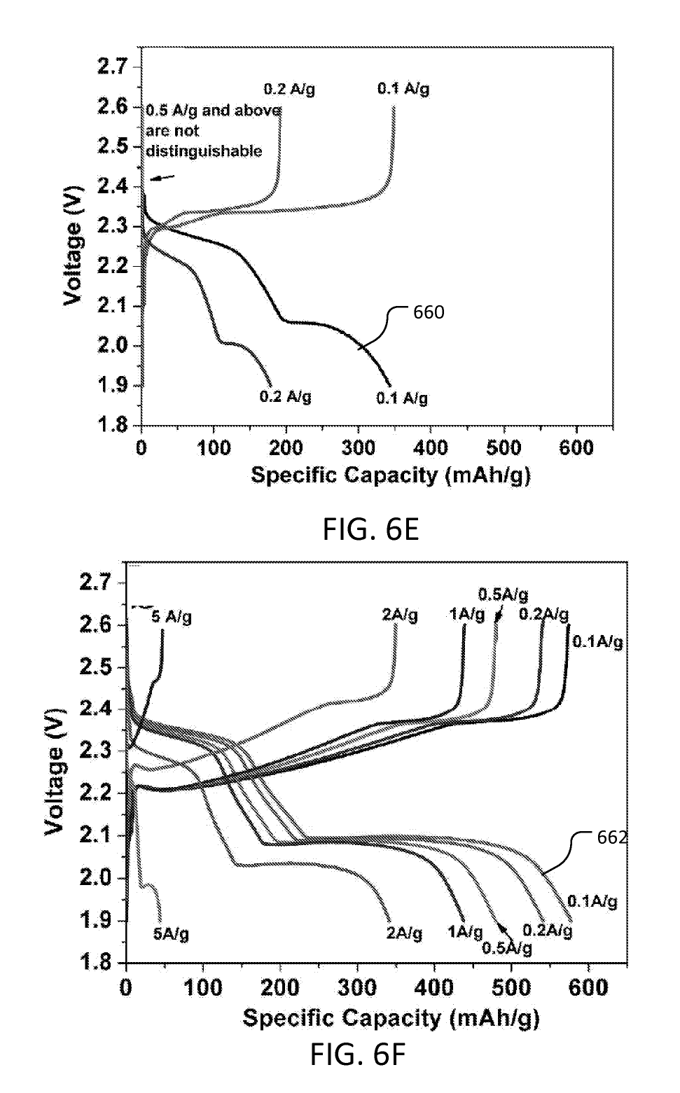

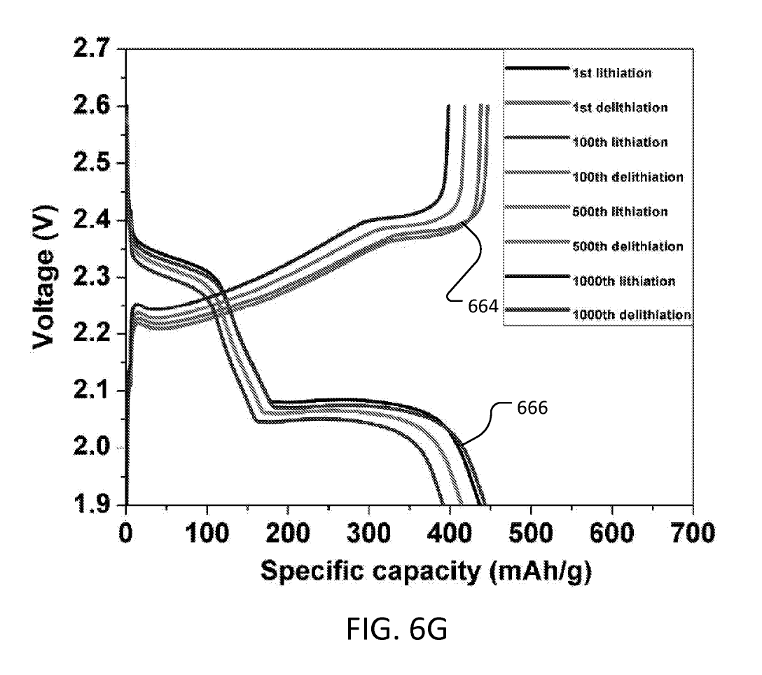

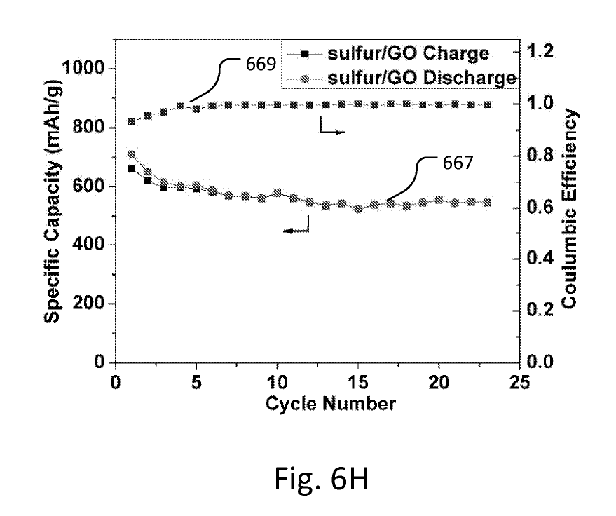

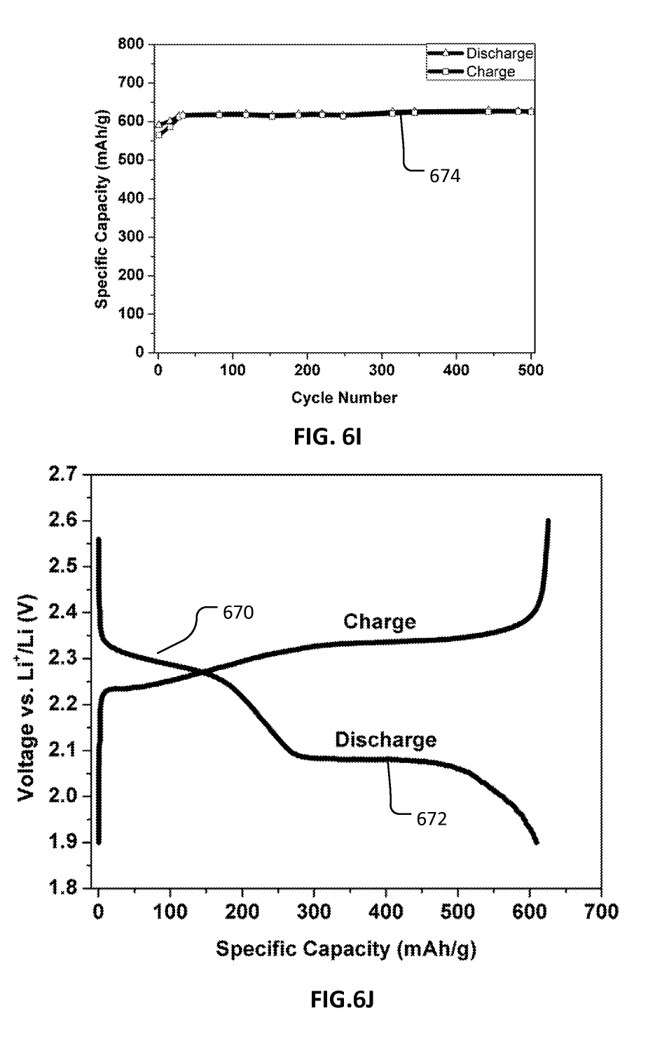

To minimize the effect of solute compounds on the composition of sulfur/GO core-shell particles, SEM characterization shown in FIGS. 3A-3F, spectroscopic characterizations shown in FIGS. 4A and 4B and battery electrochemical measurements (shown in FIGS. 6A-6J) were carried out on sulfur/GO core-shell particles prepared using a 1 M HCl solution as a dispersing medium (i.e., solution #4 in FIG. 1C).

FIG. 2C shows an image of sulfur particles 210 without GO coating. Sulfur particles 210 are separated in clusters 212, and each particle 210 has relative smooth surface.

In contrast, FIG. 3A shows that with a GO coating 310, sulfur particles are aggregated and wrapped by GO together to form a core-shell structure 312. The wrinkles 314 in FIG. 3A are from the GO coating 310. The core-shell structure 312 was formed with a weight ratio of GO to sulfur of 1:1 while FIG. 3B shows a core-shell structure 322 formed with a weight ratio of GO to sulfur of 1:5. Complete coating is achieved in both cases.

Simply by adjusting the weight ratio of GO to sulfur, the thickness of GO coating can be tuned. For example, the core-shell structure 312 in FIG. 3A is thicker than the core-shell structure 322 in FIG. 3B as the membrane of GO in the core-shell structure 322 in FIG. 3B is more transparent. As shown in FIG. 3B, even sulfur particles having very irregular shapes can be conformally coated by GO.

The density of GO (0.5˜1 g/cm³) is much lower than the density of sulfur (2 g/cm³). In ionic solutions having a high concentration of ions, GO tends to lose electrostatic repulsive force (due to screening by positive ions) and take hours to precipitate out because of their low density. Acceleration a of an object of mass m, density p, and volume Vin a fluid can be expressed as a=g−go/m, where g is the gravitational acceleration. Acceleration a increases when density increases, thus lower density leads to a longer precipitation time. During this process, if particles, such as sulfur particles, exist in the solution, GO will tend to coat on the surface of such particles in order to minimize the surface energy of GO. As shown in FIG. 1E, in molecular solutions, sulfur particles 138 precipitate by themselves because of their high density, while GO 140 is still uniformly dispersed in the solutions as a result of electrostatic repulsion among the negatively charged GO.

FIG. 2D shows a SEM image of graphene oxide wrapped sulfur particles 214 having a diameter of 1-micron. The high magnification image shows graphene oxide sheets conformally coated on a cluster of sulfur particles. The large number and high density of wrinkles 216 (marked by guiding lines) in graphene oxide sheets provide free space for volume expansion of the core sulfur particles.

FIG. 2E shows a SEM image of GO-coated sulfur structure 220 formed from sulfur particles having a diameter of 5 micron. FIG. 2E shows that sulfur particles having an irregular shape can still be well coated with GO.

The coating process of graphene oxide on particles (e.g., sulfur particles) described herein need not involve any chemical reaction. Thus the method can be extended to other particles having different chemical compositions and sizes. To verify this, the same procedures were applied to three other particles, which were sulfur particles with smaller diameter (diameter≈500 nm), ball-milled silicon particles (diameter<500 nm), and commercial carbon black particles (diameter≈100 nm).

Sulfur particles having smaller diameters (e.g., ≈500 nm) were synthesized by adding concentrated HCl (0.8 mL, 10 M) to an aqueous solution of Na₂S₂O₃ (100 mL, 0.04 M) in the presence of polyvinylpyrrolidone (PVP, Mw˜40,000, 0.02 wt %). After reacting for 2 hours, the sulfur particles were washed with ethanol and water, and dispersed into to an aqueous solution. Ball-milled silicon particles were obtained by ball-milling metallurgical silicon powder. The ball-mill (MTI Corp. of Richmond, Calif.) was typically operated at a grinding speed of 1200 rpm for 5 hours. The ground powder has a dark-brown color.

As expected, each of the three kinds of particles precipitated out with GO coating on their outer surface in the ionic solutions, while the particles sediment by themselves without GO coating in molecular solutions. SEM characterization confirms the complete and uniform wrapping of GO on particles. FIGS. 3C and 3D show the sulfur particles coated with GO in low and high magnifications, respectively. FIG. 3C shows a cluster 324 of sulfur particles being fully coated with graphene oxide. The diameter of the cluster 324 is over 10-micron. It can be seen that sulfur particles aggregated together, forming clusters having diameters of a few microns, and GO with wrinkles 326 coated on the clusters conformally. Similarly, silicon-particle aggregates 330 and carbon black aggregates 340 were coated with wrinkled GO 332, as shown in FIGS. 3E and 3F, respectively. Solution #4 was used as the dispersing medium in both cases.

FIG. 4A shows infrared spectroscopy (IR) characterization of i) GO (spectrum 410), ii) bare sulfur particles (spectrum 420), and iii) sulfur/GO core-shell particles of FIG. 3A (spectrum 430). The core-shell particles in FIG. 3A have a sulfur to GO weight ratio of 1:1, and the diameter of the sulfur particles is between 1 μm and 10 μm. Solution #4 was used as the dispersing medium in the synthesis of these core-shell particles.

The following functional groups are identified in the spectrum 410 of GO: O—H stretching vibration (3420 cm⁻¹), C═O stretching vibration (1720-1740 cm⁻¹), C═C from unoxidized sp² C—C bonds (1590-1620 cm⁻¹), and C—O vibration (1250 cm⁻¹). The spectrum 420 from bare sulfur shows a smooth curve, and no identifiable signal between 1000 cm′ and 3700 cm⁻¹, indicating that sulfur lacks the corresponding functional group on its surface. The IR spectrum 430 from sulfur/GO core-shell particles exhibited exactly the same peak positions as that of GO in spectrum 410, suggesting that all the functional groups from GO remain intact after coating, and also confirming the existence of GO in sulfur/GO core-shell particles. These result also show that there was no chemical reaction between GO and sulfur during the synthesis of sulfur/GO core-shell particles. The tendency of GO to lower its surface energy is the driving force leading to the coating of GO on sulfur particles.

FIG. 4B shows Raman spectroscopy characterization of i) GO (spectrum 440), ii) bare sulfur particles (spectrum 450), and iii) sulfur/GO core-shell particles (spectrum 460) conducted with laser radiation having a wavelength of 514 nm. Each of GO, bare sulfur and sulfur/GO core-shell particles are deposited on a silicon wafer substrate during the Raman spectroscopy characterization. Raman spectra 440 and 460 show tangential G modes at ˜1590 cm⁻¹ and disorder-induced D modes at ˜1350 cm⁻¹ from both GO and sulfur/GO, confirming the existence of GO in both samples. An ideal graphene structure of 2-dimensional hexagonal lattice of carbon atoms would not yield a D mode peak in a Raman spectrum. The intensity of the D mode peak in a Raman spectrum increases when disorders in the graphene structure increases. The I_{D}/I_{G} ratios (i.e., the ratio of the intensity of the D mode peak to the intensity of the G mode peak) of both GO and sulfur/GO were calculated to be around 0.8, indicating that the quality of GO did not change much after coating on sulfur particles. There is no observable peak between 1200 cm⁻¹ to 1700 cm⁻¹ in the spectrum 450 from sulfur. Neither does the silicon wafer substrate used for all Raman characterizations produce any peak in this spectral range.

FIG. 5 shows the results of thermal gravimetric analysis (TGA) measurement of sulfur/GO core shell particles between 35° C. to 400° C. at a temperature ramping rate of 1° C./min. The mass ratio versus temperature plot shows a steep drop 510 between 200° C. to 300° C., indicating the vaporization of sulfur. By measuring the change in mass, the mass percentage of sulfur can be determined.

As discussed above, an important application of sulfur is its use in lithium-sulfur (Li—S) battery cathodes. The sulfur/GO core-shell particles prepared using a sulfur/GO weight ratio of 1:1 in 1M of HCl (solution #4) with sulfur particles having a diameter of between 1 to 10 μm was used as cathode material in Li—S batteries.

Such cathode material can tackle the three major challenges faced by sulfur cathode simultaneously: GO coating can improve the electronic conductivity of bare sulfur and limit polysulphide dissolution, and rich wrinkles in GO can provide extra space for volume expansion of sulfur upon lithiation and prevent the electrode from disruption.

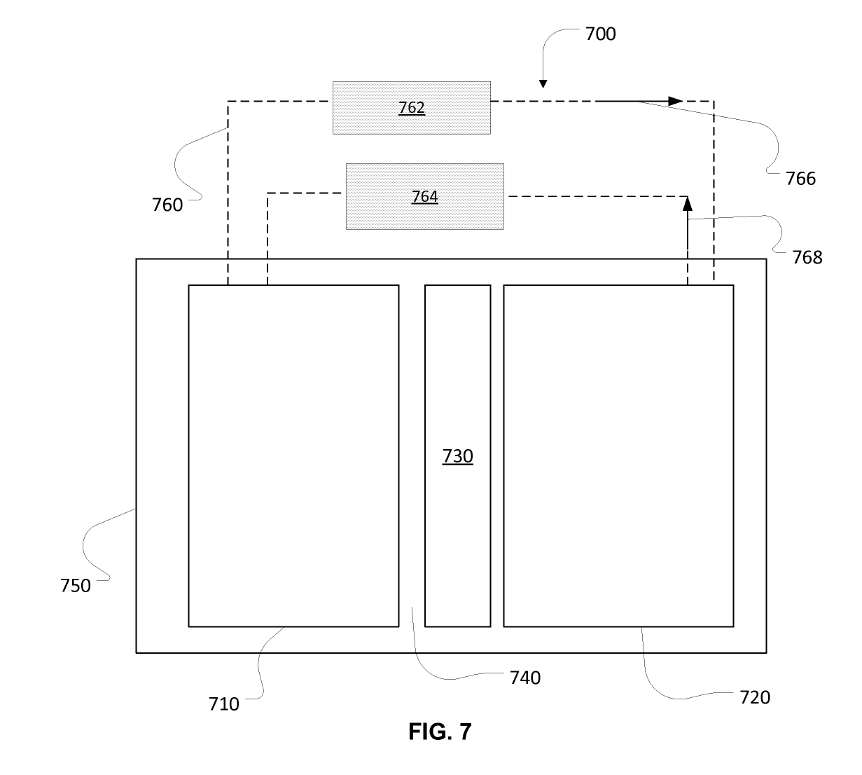

FIG. 7 shows a schematic of a battery 700. Battery 700 includes an anode 710, a cathode 720, a separator 730, and electrolytes 740, all of which are enclosed in a housing 750. Electrical connections 760 connect the anode 710 and the cathode 720 to either an external load 762 or to a charging source 764. An electron flow along the direction 766 from the anode 710 to the cathode 720 when the battery 700 discharges, powers the external load 762. During charging, electrons flow from the cathode 720 to the anode 710 along direction 768. The electrolytes 740 allow for ionic conductivity. The separator 730 separates the anode 710 and the cathode 720 to prevent a short circuit. Examples of anode include graphite, graphene, carbon nanotubes (CNT), Li-alloy, Si, TiO₂ and Sn. Examples of electrolytes include LiPF₆, LiBF₄ or LiClO₄ in organic solvent such as ethylene carbonate (EC), ethyl methyl carbonate (EMC), dimethyl carbonate (DMC) and diethyl carbonate (DEC); examples of separator includes polyethylene (PP), polypropylene (PP), trilayer PP/PE/PP. The sulfur/GO core-shell particles can be used to fabricate the cathode 720.

To demonstrate the structural benefits of sulfur/GO core-shell particles in improving cathode performance, a series of electrochemical measurements were carried out. As a comparison, bare sulfur particles without a GO coating were also tested using the same procedures. The two different materials were fabricated into working electrodes for the series of electrochemical measurements.

To prepare the working electrodes, sulfur/GO core-shell particles or bare sulfur particles can be mixed with carbon black (Super P) and polyvinylidene fluoride binder, at a weight ratio of for example, 8:1:1, in N-methyl-2-pyrrolidinone to form a slurry. Carbon black (for example, at 10% by weight), which as a very high electrical conductivity, can be used to increase electric conductivity. The slurry was then coated onto an aluminum foil using a doctor blade and dried at 60° C. for 12 hours to form the working electrodes. 2032-type coin cells were assembled in an argon-filled glovebox using lithium metal as a counter electrode. The electrolyte used in the battery was lithium bis(trifluoromethanesulfonyl)imide (1 M) in 1:1 volume ratio of 1,2-dimethoxyethane and 1,3-DOL containing 1 wt % LiNO₃.

Cyclic voltammetry and galvanostatic cycling were then carried out to study the oxidation and reduction processes involving Li⁺ and Li⁰. Galvanostatic means constant current. In galvanostatic cycling, a constant current is applied to charge and discharge the battery. For example, charging at 1 A and discharging at 1 A.

FIG. 6A shows data obtained from cyclic voltammetry (CV) that reveal the electrochemical reaction mechanism of the cathode materials. CV was conducted between 1.9 V and 2.6 V at a sweep rate of 0.1 mV/s. During the first cathodic reduction process of sulfur (S₈), a peak 604 at 2.24 V and a peak 602 at 2.0 V (vs Li⁺/Li⁰) were observed in the battery containing bare sulfur cathode material. vs Li⁺/Li⁰ denotes the use of Li metal counter/reference electrode and the use of electrolytes containing Li ions (Li⁺).

The peak 602 at 2.24 V corresponds to the reduction of sulfur to higher-order polysulfides (Li₂Sₓ, 4<x<8), i.e., Sₓ+2Li→Li₂Sₓ, 4<x<8. Sulfur on the left hand side of the equation has an oxidation of 0 while sulfur has an oxidation state of −2/x on the right hand side. The peak 604 at 2.0 V can be assigned to the reduction of higher-order polysulphides to lower-order polysulphides (Li₂Sₓ, 2≦x≦4), i.e. Li₂Sₓ, 4<x<8→Li₂Sₓ, 2<x<4+yS. This reaction happens at the electrode upon the application of either a positive or negative voltage to the electrode. No oxidizing agent is needed and no lithium metal) (Li⁰) is produced.

The driving voltage in CV is then reversed and driven from 2.6 V to 1.9 V. In the following anodic oxidation process, a peak 606 at approximately 2.4 V and a peak 608 at approximately 2.3 V were observed and can be attributed to the conversion of lithium sulphides (Li₂S) to polysulphides, and polysulphides to sulfur, respectively.

Sulfur/GO core-shell particles also have four corresponding peaks 612, 614, 616, and 618, however, at slightly shifted positions. The two anodic peaks 616 and 618 were shifted to lower voltages by about 0.07 V, while the two cathodic peaks 612 and 614 had much smaller shifts. It is noted that the cathodic peak 614 shifted to lower voltage by 0.05 V after GO coating. Such characteristic may be caused by side effects from a trace amount of moisture in the sulfur/GO sample. The voltage difference between charge and discharge plateaus (i.e., the difference between peaks the 614 and 618 vs. the peaks 604 and 608) of sulfur/GO was overall much smaller than that of sulfur, suggesting that GO coating leads to better conductivity of the sulfur/GO core-shell particles, which can reduce the polarization and inner resistance of the batteries. Better conductivity can mean faster electron transport, which allows faster charge/discharge. Lower polarization and inner resistance are factors in achieving long-cycle stability and high power density in batteries and help to improve their overall performance.

FIG. 6J shows a charge voltage profile and a discharge voltage profile. The two voltage plateaus 670 and 672 during discharge are at 2.3V and 2.1V vs. Li/Li+, which are typical for sulfur-based cathode material.

To further investigate the structural benefits of sulfur/GO core-shell particles compared to bare sulfur, electrochemical impedance analyses were conducted on both battery cells at 100 kHz to 10 mHz. The impedance of the cathode in the Li—S batteries depends strongly on the lithium content inside the electrode materials. To maintain uniformity, electrochemical impedance spectroscopy measurements were carried out on the working electrodes in the delithiated state after the first cycle (i.e., after a first discharge to 1.9 V and a first charging to 2.6V).

The Nyquist plots obtained are shown in FIG. 6B. Each data point in FIG. 6B is measured at a different frequency. A higher frequency is used for data points closer to the origin, though the actual frequency is not labeled in this figure. The high frequency measurement data corresponds to the ohmic serial resistance Rₛ, which includes both the sheet resistance of the electrode and the resistance of the electrolytes.

A semicircle 620 in the middle frequency range indicates the charge transfer resistance R_{ct}, relating to the charge transfer through the electrode/electrolyte interface and the double layer capacity C_{dl} formed due to the electrostatic charge separation near the electrode/electrolyte interface. Data points approximating an inclined line 622 in the low frequency represent the Warburg impedance Wₒ, which is related to solid-state diffusion of lithium-ions into the electrode material.

Sulfur/GO core-shell particles clearly showed a significantly smaller semicircle 624 than sulfur does, and the charge transfer resistance (i.e., the resistance at the “dip” in the graph) was reduced from 200Ω for the sulfur sample to 25Ω for the sulfur/GO sample. In addition, the serial resistance, which is the ohmic serial resistance, (and also the first data point in the respective plots shown in FIG. 6B) reduced from 12Ω to 6.5Ω after GO coating, indicating a better electrical conductivity of the electrodes. The serial resistance is measured at high frequency. Decreased charge transfer resistance and serial resistance are both favorable to achieving high current rate performance.

Results from galvanic current measurements carried out on both sulfur/GO and sulfur, used as a cathode material in two different Li—S batteries, at different current rates are shown in FIG. 6C. Current rate (C-rate) is the ratio of a given current over the current that a battery can sustain for one hour. Discharging a 1.6Ah battery at a C-rate of 1 C would mean discharging the battery in one hour at a discharge current of 1.6 A. Discharging the same battery at a C-rate of 2C would mean discharging the battery in half an hour at a discharge current of 3.2 A.

Sulfur/GO has slightly lower specific capacity in the first three cycles than that of sulfur, as shown in plot 630, owing to the fact that the weight of GO is taken into calculation but it (i.e., GO) does not contribute too much capacity. After 10 cycles at 0.1 C rate (1 C=1000 mA/g), specific capacity approaches 600 mAh/g for sulfur/GO, and the corresponding Coulombic efficiency is over 99%. Here, Coulombic efficiency refers to the percentage ratio of charge capacity to discharge capacity. At a Coulombic efficiency of 99%, 99 Li⁺ ions are released from sulfur during charging for every 100 Li⁺ ions inserted into the sulfur during discharge. A higher Columbic efficiency indicates better performance. In comparison, the specific capacity is only 350 mAh/g for sulfur under the same test condition. The improvement in cycling stability of sulfur/GO is more significant as the current rate increases, as shown in the curve 630. Sulfur/GO showed capacities of 550, 500, 450, 350, and 50 mAh/g at the current rates of 0.2 C, 0.5 C, 1 C, 2 C, and 5 C, respectively.

In contrast, sulfur only exhibits a specific capacity of 200 mAh/g at the current rates of 0.2 C, and negligible values at all higher current rates tested. Moreover, sulfur/GO recovers most of the original capacity when the cycling current rate is restored to 0.1 C, implying that the structure of sulfur/GO electrode remained stable even under high rate cycling. The enhanced cycling stability and high current rate performance can be attributed to the unique structure of conformal coating of the wrinkled GO on sulfur.

FIG. 6E show various voltage profiles at different current rates for sulfur and FIG. 6F show various voltage profiles at different current rates for sulfur/GO core-shell particles. Each curve depicted in FIGS. 6E and 6F was measured by first applying a constant current, for example, of 0.1 A/g. The voltage is then measured every second. The horizontal axis essentially denotes the evolution of time. As current is maintained at a constant value, the horizontal axis can be converted into specific capacity, (i.e., mAh/g=0.1 mA/g×time). The specific capacity for various current rates in sulfur/GO core-shell particles is about two times higher than the corresponding current rates in bare sulfur structures at similar voltages. For example, a curve 660 in FIG. 6E shows specific capacity that is more than about half that shown in a curve 662 of FIG. 6F. Both curves 660 and 662 are obtained at a current rate of 0.1 A/g.

Further galvanic current tests demonstrate that sulfur/GO maintains a capacity as high as 400 mAh/g at 1 A/g over 1000 cycles when the total mass of sulfur/GO is taken into calculation, as shown in FIG. 6D. Specific capacity based on the weight of sulfur only is calculated to be around 800 mAh/g after 1000 cycles, as shown in a curve 642, which is over 6 times larger than that of commercial metal oxide cathode materials (e.g. LiCoO₂=120 mAh/g). A curve 640 shows the specific capacity based on the weight of both sulfur and GO. The curve 644 shows the Coulombic efficiency over 1000 cycles.

FIG. 6I shows charge/discharge cycling measurement 674 of sulfur/GO core-shell particles at a current rate of 1000 mAh/g. At this current rate, only 0.5 hour is needed to fully charge or discharge the battery. Negligible degradation in specific capacity over 500 cycles of charge/discharge was seen. After 500 cycles, there is still a remaining specific capacity of over 600 mAh/g, which is 5 times as high as that of commercial cathode (LiCoO₂).

Voltage profiles of selected cycles (1st, 100th, 500th, and 1000th) are shown in FIG. 6G. For example, a curve 664 shows the voltage profile after 100 delithiation steps, while a curve 666 shows the voltage profile after 100 lithiation steps. Lithiation refers to chemical reactions between lithium and sulfur, or the insertion of lithium into sulfur to form compounds. Delithiation refers to the release of lithium from sulfur. The Coulombic efficiency was mostly above 99.5% after the first three cycles. The sulfur/GO cathode exhibits less than 0.02% specific capacity degradation per cycle over 1000 cycles. The complete conformal coating of GO on sulfur prevents sulfur from dissolving into the electrolyte, and results in improved cycling performance. Further improvement in cyclability and rate capability is achieved by combining this method with other strategies such as conductive polymer coating.

Galvanic current test at low current rate (50 mA/g) was also carried out and showed good stability over 23 cycles, as shown in FIG. 6H. A curve 667 shows the specific capacity over the 23 cycles while a curve 669 shows the Coulombic efficiency over the 23 cycles. Batteries can have a higher discharge capacity than charging capacity in the first few cycles because not all of the lithium ions inserted into sulfur during discharge can be released upon charging. In other words, the reaction is not 100% reversible, especially in the first few cycles. The improved electrochemical performance may be due to the complete wrapping of GO over sulfur particles achieved by engineering the ionic strength of solutions. A spacing between stacked GO layers can be used as a channel for lithium ion transportation. The small spacing would significantly slow down polysulphide dissolution thus leading to excellent cycling stability. This may also explain the small but nonzero capacity decay over long cycles.

In addition to sulfur, lithiated sulfur (LiₓS; 0<x≦2) is also a promising cathode material with a high theoretical capacity of 1166 mAh/g for Li₂S based on the electrochemical reaction: 8Li₂S←→S₈+16Li, which is over 7 times higher than commercial metal oxide based cathodes. An advantage of lithiated sulfur is its ability to be paired with lithium metal-free anodes (such as silicon) to form a full battery, hence avoiding dendrite formation and safety concerns associated with metallic lithium. While bare (i.e., uncoated) sulfur can expand 80% during initial lithiation, Li₂S shrinks as it is delithiated initially, generating empty space for subsequent volumetric expansion during lithiation. Li₂S thus mitigates against structural damage to the electrode. However, Li₂S cathodes have low electronic and ionic conductivity and may dissolve intermediate lithium polysulfide species (Li₂Sₙ) into the electrolyte, resulting in fast capacity fading and low Coulombic efficiency.

Li₂S can be used as the core material and be coated with coating materials that have a better electric conductivity than that of Li₂S for use as a cathode material in rechargeable lithium batteries. The coated Li₂S particles would have increased electric conductivity and can also mitigate the dissolution of intermediate lithium polysulfide species at the same time. The Li₂S core materials can have diameters between 10 nm and 100 micrometers. The coating material can be polymers, surfactant molecules, or carbon materials, or any combination of thereof. The coating materials can have a thickness between 1 nm and 1 micrometer. The polymer coating can include conductive polymers, such as poly(fluorene)s, polyphenylenes, polypyrenes, polyazulenes, polynaphthalenes, poly(acetylene)s, poly(p-phenylene vinylene), poly(pyrrole)s, polycarbazoles, polyindoles, polyazepines, polyanilines, poly(thiophene)s, poly(3,4-ethylenedioxythiophene), poly(p-phenylene sulfide).

The coating can also include surfactants, such as octenidine dihydrochloride, cetyl trimethylammonium bromide, hexadecyl trimethyl ammonium bromide, cetyl trimethylammonium chloride, cetylpyridinium chloride, benzalkonium chloride, benzethonium chloride, 5-bromo-5-nitro-1,3-dioxane, Dimethyldioctadecylammonium chloride, cetrimonium bromide, dioctadecyldimethylammonium bromide, ammonium lauryl sulfate, sodium dodecyl sulfate, sodium laureth sulfate, sodium myreth sulfate, dioctyl sodium sulfosuccinate, perfluorooctanesulfonate, perfluorobutanesulfonate, linear alkylbenzene sulfonates, polyoxyethylene glycol alkyl ethers, polyoxypropylene glycol alkyl ethers, glucoside alkyl ethers, polyoxyethylene glycol octyphenol ethers, polyoxyethylene glycol alkylphenol ethers, glycerol alkyl esters.

The coating can also include carbon materials, such as graphene, graphene oxide, graphite, amorphous carbon, fullerenes, carbon black, carbon nanotube, carbon nanofiber. Carbon nanofibers are sp²-based linear, non-continuous filaments having a diameter in the range of hundreds of nanometer and greater than a few micrometers in length.

Instead of GO, chemically reduced GO can also be used to wrap core materials. Reduced GO has better electrical conductivity than GO. Electrical conductivity of sulfur and GO is 1×10⁻¹⁵ S/m, and 0.1˜0.5 S/m, respectively. GO can be first reduced and then be used to wrap up core materials or GO can be used to wrap up core materials prior to chemically reduce the core-shell structure. The membrane-like GO is composed predominantly of carbon, it also includes some functional groups containing oxygen and hydrogen. The reduction reaction is a process used to partially remove the functional groups. Reduced GO has a higher percentage of carbon, and higher electric conductivity.

For example, hydrazine monohydrate can be used as a reduction agent to chemically reduce GO in which 1 μL of hydrazine monohydrate is added to every 3 mg of GO dispersed in water. The reaction can be conducted at an elevated temperature (e.g., of 80 to 100° C.) and takes between 0.1 to 12 hours for completion.

The methods disclosed herein provide a facile, robust, and generic method of coating graphene oxide (GO) on particles by engineering the ionic strength of solutions. The methods can be applied to a wide range of core materials (e.g., silicon, lithiated sulfur, carbon black). Uniform coating of wrinkled GO on various particles with a wide range of sizes, geometries, and compositions in an aqueous solution medium can be obtained. Besides the excellent battery performance, the methods disclosed herein are simple and low-cost, as they involve commercial sulfur powder, graphene oxide (which can be produced in a large quantity and low cost), aqueous acid solution and mechanical stirring. In addition, the product is in the form of powder, which is fully compatible with the current industrial manufacturing process.

In some embodiments, sulfur/GO core-shell particles as Li—S battery cathode material show a specific capacity of 800 mAh/g after 1000 cycles at 1 C(=1 A/g) current rate if only the mass of sulfur is taken into calculation, and 400 mAh/g if the total mass of sulfur/GO is considered. The capacity decay over 1000 cycles is less than 0.02% per cycle.

While this specification contains many implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular embodiments of the invention have been described. Other embodiments are within the scope of the following claims.

What is claimed is:

1. A method comprising:
combining a coating material and an uncoated particulate core material in a solution having a selected ionic strength, wherein the selected ionic strength promotes coating of the uncoated particulate core material with the coating material to form coated particles; and
collecting the coated particles, wherein the coating material has a higher electrical conductivity than the core material.

2. The method of claim 1, wherein surface energy reduction drives the coating of the core material by the coating material.

3. The method of claim 1, wherein the particulate core material has a diameter of 10 nm to 100 micron.

4. The method of claim 1, wherein the coating material is a carbon material or a polymer.

5. The method of claim 4, wherein the coating material comprises graphene oxide.

6. The method of claim 5, further comprising reducing the graphene oxide to form reduced graphene oxide coated particles to further increase electrical conductivity.

7. The method of claim 1, wherein the coated particles are conformally coated with the coating material having a thickness between 1 nanometer and 1 micrometer.

8. The method of claim 1, wherein the ionic strength of the solution is selected to achieve a wrinkled and crumpled morphology in the coating material on the coated particle.

9. The method of claim 1, wherein the uncoated particulate core material comprises lithiated sulfur and a ratio of lithium to sulfur is less than or equal to two.

10. The method of claim 1, wherein the coating material comprises a particulate coating material.

11. A cathode for a lithium ion battery comprising the coated particles of claim 1, wherein the coating material comprises graphene oxide (GO), and rich wrinkles in the GO provide space for volume expansion of sulfur upon lithiation and prevent the cathode from disruption.

12. The method of claim 1, wherein the solution comprises an acidic aqueous solution.

13. The method of claim 12, wherein the acidic aqueous solution comprises one or more of hydrochloric acid, nitric acid, sulfuric acid, and acetic acid at a concentration between 0.001 mol/L to 10 mol/L.

14. A battery comprising:
an anode;
a cathode having a specific capacity greater than 150 mAh/g; and
an electrolyte disposed between the anode and the cathode,
wherein the cathode comprises conformally coated particles formed from an uncoated particulate core material and a coating material, the coating material having a higher electrical conductivity than the core material.

15. The battery of claim 14, wherein the anode is lithium metal-free.

16. The battery of claim 14, wherein the uncoated particulate core material comprises sulfur and the coating material is configured to reduce dissolution of sulfur into the electrolyte.

17. The battery of claim 14, wherein the coating material on the coated particles comprises a layer having a wrinkled and crumpled morphology.

18. The battery of claim 17, wherein the wrinkled and crumpled morphology provides space for volume expansion in the cathode that reduces degradation of the cathode.

19. The battery of claim 14, wherein the cathode has a specific capacity greater than 550 mAh/g after 10 charging cycles at a 0.1 C rate and a Coulombic efficiency greater than 99%.

20. The battery of claim 14, wherein the cathode has a specific capacity greater than 500 mAh/g at a 0.1 C rate after operating at a current rate greater than 2 C.

21. The battery of claim 14, wherein the cathode has a specific capacity of not less than 800 mAh/g after 1000 charging cycles at a 1 C rate based on a mass of the core material, and a specific capacity of 400 mAh/g based on a mass of the core material and the coating material.

22. The battery of claim 21, wherein a drop of the specific capacity over 1000 cycles is less than 0.02% per cycle.

23. The battery of claim 14, wherein the coating material comprises stacked graphene oxide layers, a spacing between the stacked GO layers forms a channel for lithium ion transportation.

24. A method comprising:
selecting an ionic strength in a solution based on a combination of uncoated particulate core material and a coating material;
combining the coating material and the uncoated particulate core material in the solution having the selected ionic strength, the selected ionic strength promotes coating of the core material with the coating material to form coated particles; and
collecting the coated particles,
wherein the uncoated particulate core material is selected from the group consisting of sulfur, lithiated sulfur, silicon, and carbon black, and the coating material is selected from the group consisting of graphene oxide, and conductive polymers.
